(19) United States
(12) Patent Application Publication
(10) Pub. No.: US 2012/0206852 A1
(43) Pub. Date: Aug. 16, 2012

(54) NOTCHED WASHER TO IMPROVE SURFACE AREA FOR GROUNDING OF CONDUCTIVE PLASTICS

(75) Inventor: Todd Fitz, Marysville, OH (US)

(73) Assignee: Honda Motor Co., Ltd., Tokyo (JP)

(21) Appl. No.: 13/024,800

(22) Filed: Feb. 10, 2011

(51) Int. Cl. H05F 3/02

(52) U.S. Cl. 361/216

(57) ABSTRACT

An electrical grounding apparatus for a vehicle includes an inner wall spaced apart from an outer wall, a first contacting surface having a plurality of elevated portions, and a second contacting surface. The elevated portions of the first contacting surface extend at least partially into the first vehicle component creating electrical contact between the first contacting surface and a first vehicle component. The second contacting surface makes electrical contact with the second vehicle component. The electrical grounding apparatus is substantially formed of an electrically conductive material, which provides electrical contact between the first and second vehicle components.

### I. BACKGROUND

A. Field of Invention

This invention relates generally to apparatus for grounding components in vehicles and more particularly to washers for improving grounding of electrically conductive plastics.

B. Description of the Related Art

It is well known in the art to apply electrically conductive plastic in an automotive body-in-white. It is also well known to paint a body-in-white with an electrostatic painting process. Conductive plastic must be properly grounded to the body during painting or the paint will not achieve appropriate film thickness. If the conductive plastic is not properly grounded, the plastic builds up an electrical charge during painting preventing the paint from reaching the conductive plastic. Various factors can interfere with proper grounding of the conductive plastic. The conductive plastic can expand due to the heat generated during the painting process disrupting the electrical ground connection. In addition, paint can get between the plastic and the body-in-white to weaken or interrupt the electrical ground connection.

Therefore, what is needed are apparatus and methods, which adequately ground the electrically conductive plastic to prevent the buildup of an electric charge in the conductive plastic during painting. Embodiments of the present invention overcome one or more of the deficiencies in the prior art.

II. SUMMARY

According to one embodiment of this invention, an electrical grounding apparatus for a vehicle includes an outer wall; an inner wall spaced apart from the outer wall; a first contacting surface comprising a plurality of elevated portions, wherein the first contacting surface makes electrical contact with a first vehicle component, and wherein the elevated portions extend at least partially into the first vehicle component; and a second contacting surface, wherein the second contacting surface makes electrical contact with a second vehicle component; wherein the electrical grounding apparatus is substantially formed of an electrically conductive material. The second contacting surface can include a plurality of elevated portions, which extend at least partially into the first vehicle component. The plurality of elevated portions can increase the surface area of the contacting surfaces. In some embodiments, both the outer wall and the inner wall of the electrical grounding apparatus are substantially circular. The electrical grounding apparatus can be formed of a substantially metallic material or of a metal, which provides electrical contact between the first and second vehicle components.

According to another embodiment, a vehicle painting apparatus includes a first vehicle component formed of an electrical conductive plastic; a second vehicle component formed of an electrically conductive material, wherein the second vehicle component is electrically grounded; and an electrical grounding apparatus substantially formed of an electrically conductive material. In some embodiments, the electrical grounding apparatus includes an outer wall; an inner wall spaced apart from the outer wall; a first contacting surface comprising a plurality of elevated portions, wherein the first contacting surface makes electrical contact with the first vehicle component, and wherein the elevated portions extend at least partially into the first vehicle component; and a second contacting surface, wherein the second contacting surface makes electrical contact with the second vehicle component; and an electrostatic paint spraying system providing paint for the first and second vehicle components. The second vehicle component can substantially be formed of a metallic material or of metal. The outer and inner walls of the electrical grounding apparatus can be substantially circular. The vehicle painting apparatus can further include a second electrical grounding apparatus substantially formed of an electrically conductive material, the second electrical grounding apparatus comprising: an outer wall; an inner wall spaced apart from the outer wall; a first contacting surface comprising a plurality of elevated portions, wherein the first contacting surface makes electrical contact with the first vehicle component, and wherein the elevated portions extend at least partially into the first vehicle component; and a second contacting surface, wherein the second contacting surface makes electrical contact with a fastener; wherein the fastener secures the first vehicle component to the second vehicle component, the first electrical grounding apparatus between the first and second vehicle components, and the second electrical grounding apparatus between the fastener and the first vehicle component. The second contacting surface of the second electrical grounding apparatus can include a plurality of elevated portions, which extend at least partially into the fastener. The electrostatic paint spraying system can provide a positive charge to the first and second vehicle components and spray or otherwise deposit negatively charged paint on the first and second vehicle components.

According to another embodiment, a method of grounding a vehicle component includes providing a first vehicle component formed of an electrical conductive plastic; providing a second vehicle component formed of an electrical conductive material, wherein the second vehicle component is electrically grounded; providing an electrical grounding apparatus substantially formed of an electrically conductive material. The electrical grounding apparatus includes an outer wall; an inner wall spaced apart from the outer wall; a first contacting surface comprising a plurality of elevated portions, wherein the first contacting surface makes electrical contact with the first vehicle component, and wherein the elevated portions extend at least partially into the first vehicle component; and a second contacting surface, wherein the second contacting surface makes electrical contact with the second vehicle component.

One advantage of this invention is that the electrical conductive plastic of a body-in-white can be properly grounded.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a body-in-white, according to one embodiment;

FIG. 2 is a diagram of an electrostatic painting process, according to one embodiment;

FIG. 3 is an exploded view of an electrical grounding apparatus, according to one embodiment;

FIG. 4 is an exploded view of an electrical grounding apparatus, according to one embodiment;

FIG. 5 is a top view of an electrical grounding apparatus, according to one embodiment;

FIG. 6 is a side view of an electrical grounding apparatus, according to one embodiment;

FIG. 7 is a side view of an electrical grounding apparatus, according to one embodiment;

FIG. 8 is a side view of an electrical grounding apparatus, according to one embodiment;

FIG. 9 is a side view of an electrical grounding apparatus, according to one embodiment;

FIG. 10 is a side view of an electrical grounding apparatus, according to one embodiment;

FIG. 11 is a side view of an electrical grounding apparatus, according to one embodiment;

FIG. 12 is an assembled view of an electrical grounding apparatus, according to one embodiment; and

FIG. 13 is an assembled view of an electrical grounding apparatus, according to one embodiment.

### IV. DETAILED DESCRIPTION OF THE INVENTION

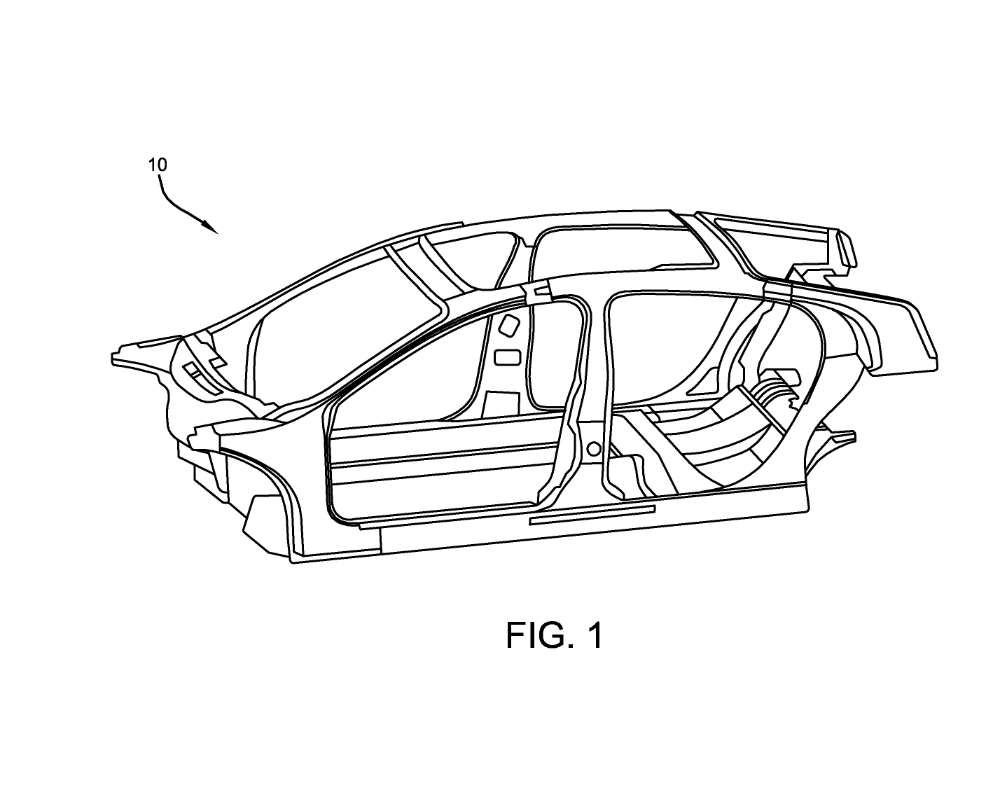

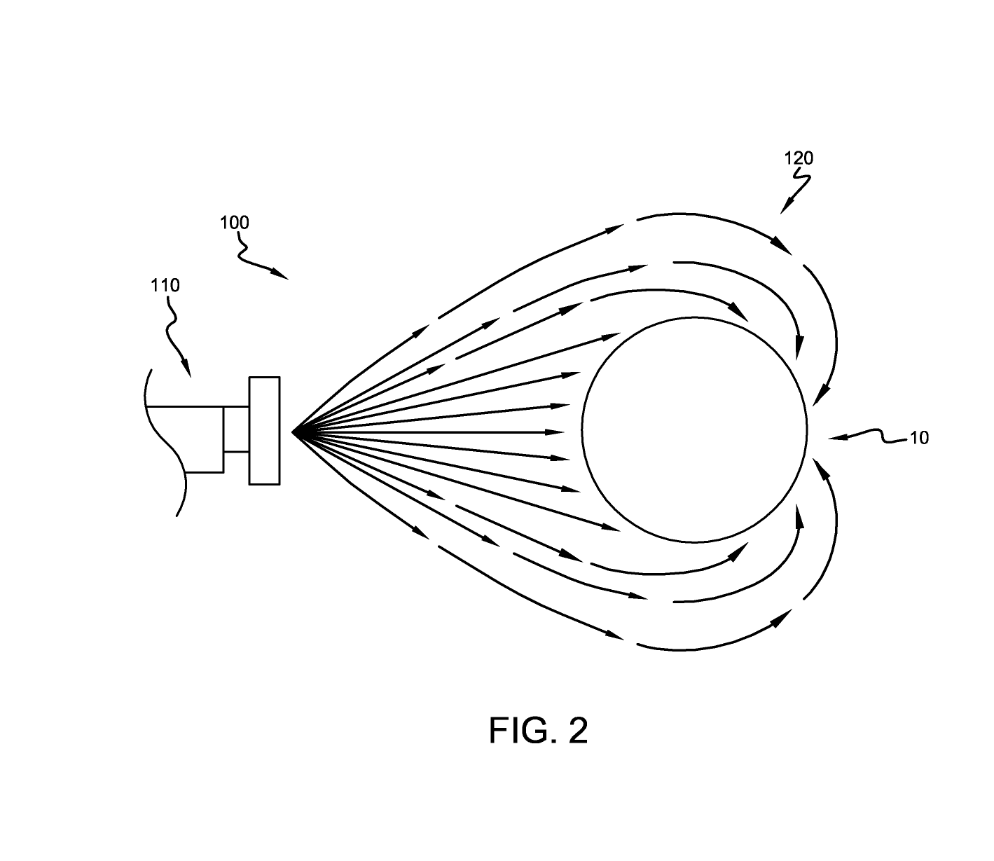

Referring now to the drawings wherein the showings are for purposes of illustrating embodiments of the invention only and not for purposes of limiting the same, and wherein like reference numerals are understood to refer to like components, FIG. 1 shows an automotive body-in-white 10, which can include many different materials including, but not limited to, metal, metallic materials, plastics, and conductive plastics. FIG. 2 shows a portion of the body-in-white 10 in an electrostatic painting process 100, as is well known in the art. The electrostatic painting system 100 can include a delivery device or spray nozzle 110. In some embodiments, an electrostatic painting system 100 provides a positive charge to the body-in-white 10 and a negative charge to the electrostatic paint 120, which is sprayed or otherwise deposited on the body-in-white 10.

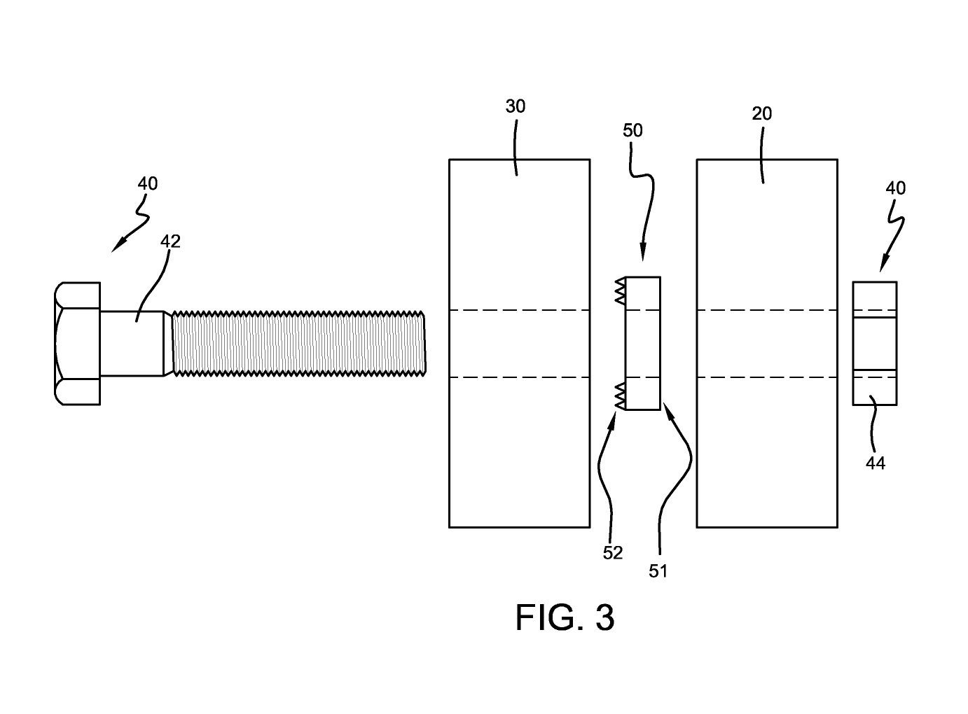

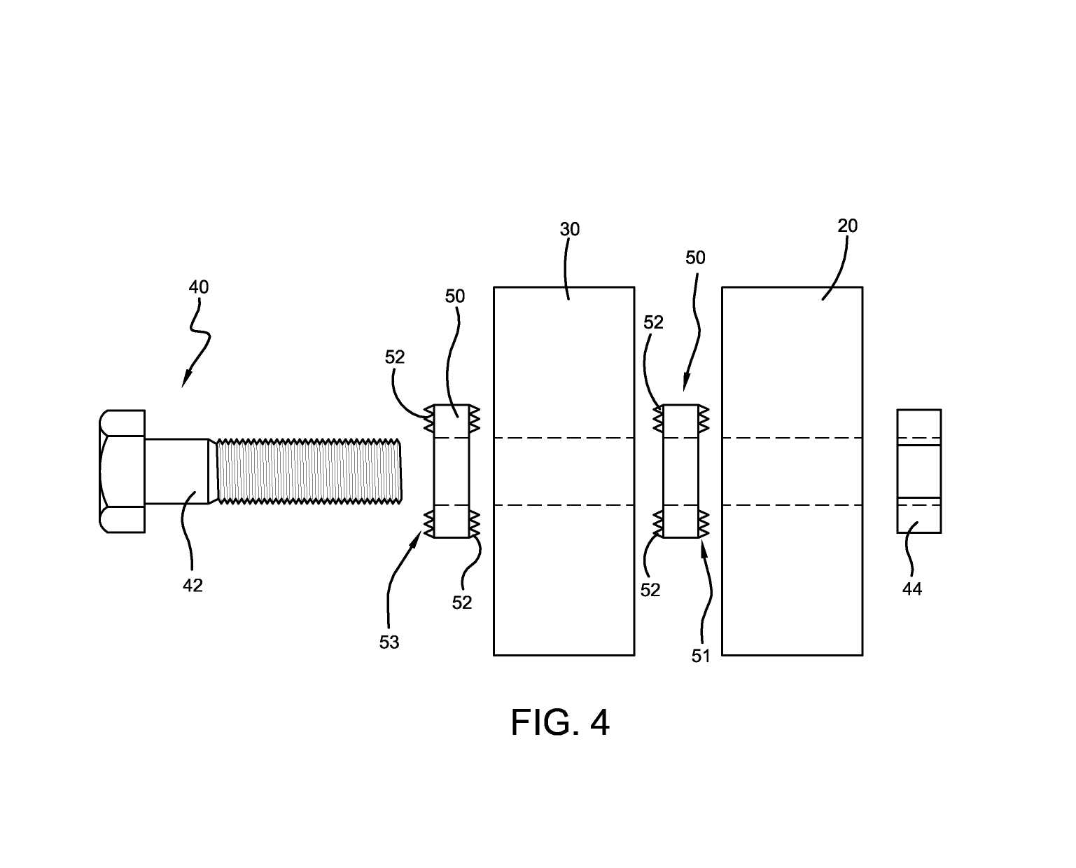

With reference now to FIGS. 3 and 4, the body-in-white 10 can include components 20 made of metals or metallic materials and components 30 made of electrically conductive plastic. The conductive plastic 30 needs to have a good electrical connection with metal or metallic materials 20. The conductive plastic 30 and the metallic component 20 can be fastened or secured together with a fastener 40 including, but not limited to, a bolt, a screw, a rivet, or any other fastening means chosen by a person of ordinary skill in the art. In one embodiment, the fastener 40 is a bolt 42 and nut 44. An electrical grounding apparatus or washer 50 can be positioned between the conductive plastic 30 and the metallic component 20. The electrical grounding apparatus 50 can be made of metal, metallic materials, or other electrically conductive material chosen by a person of ordinary skill in the art. The electrical grounding apparatus 50 can include raised or elevated portions 52, which increase the surface area of the electrical grounding apparatus 50 for improved electrical connectivity. The elevated portions 52 can extend at least partially into the conductive plastic 30 when the conductive plastic 30 is secured to the metallic component 20. In some embodiments, the elevated portions 52 extend substantially completely into the conductive plastic 30. These raised or elevated portions 52 provide an electrical connection from the conductive plastic 30 to the electrical grounding apparatus 50. The contact surface 51 between the electrical grounding apparatus 50 and the metallic component 20 provides an electrical connection from the electrical grounding apparatus 50 to the metallic component 20, which is electrically grounded or can have a positive charge. The electrical grounding apparatus 50 can also include elevated portions 52 on the contact surface 51, as further described below.

With continued reference to FIGS. 3 and 4, a second electrical grounding apparatus or washer 50 can be positioned between the conductive plastic 30 and the fastener 40. The electrical grounding apparatus 50 can include raised or elevated portions 52 that extend at least partially into the conductive plastic 30 when the conductive plastic 30 is secured to the metallic component 20. These raised or elevated portions 52 provide an electrical connection from the conductive plastic 30 to the second electrical grounding apparatus 50. The contact surface 53 between the electrical grounding apparatus 50 and the fastener 40 provides an electrical connection from the electrical grounding apparatus 50, through the fastener 40, to the metallic component 20, which is electrically grounded or can have a positive charge. The electrical grounding apparatus 50 can also include elevated portions 52 on the contact surface 53, as further described below.

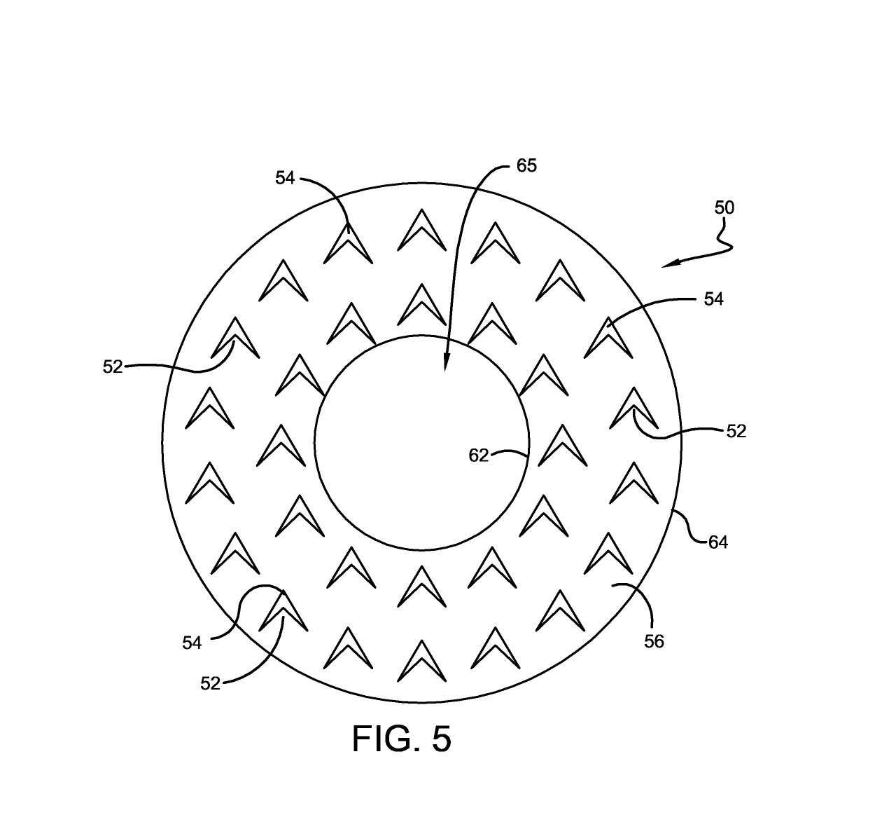

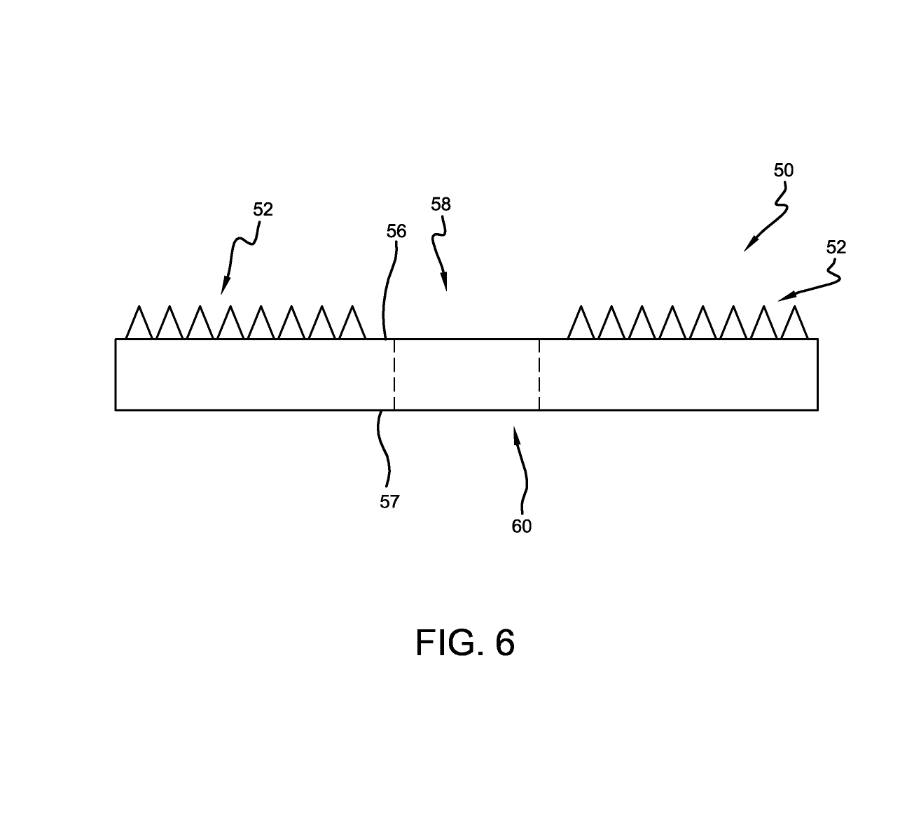

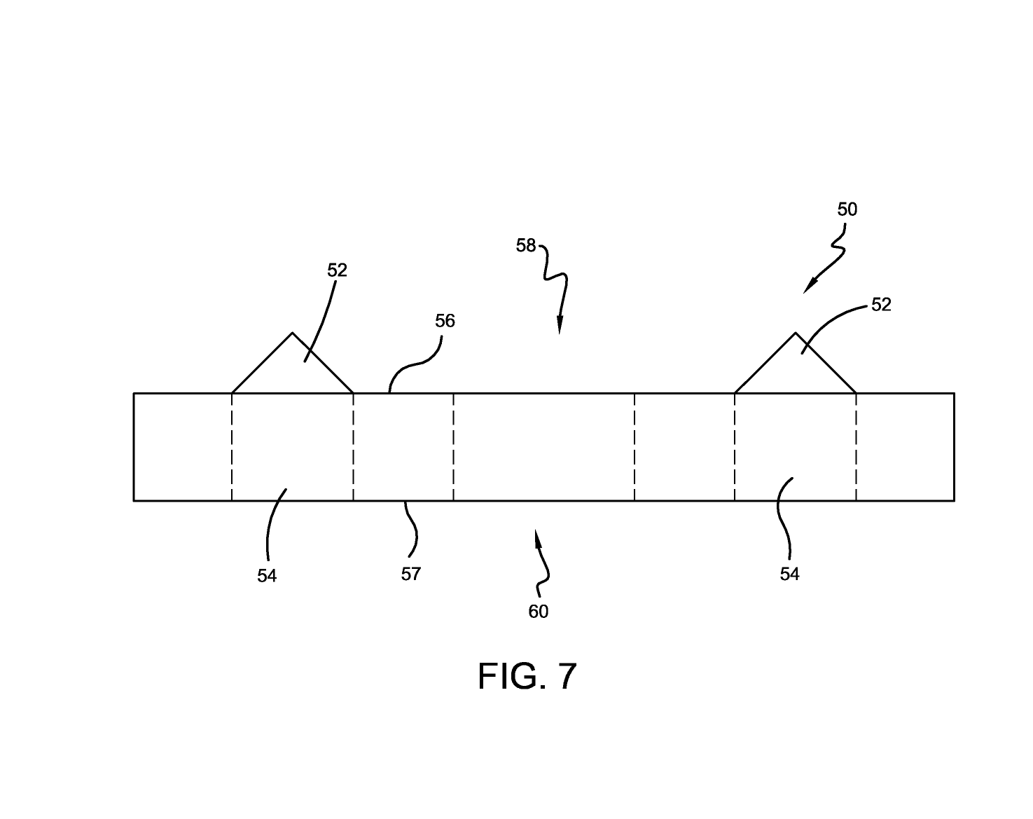

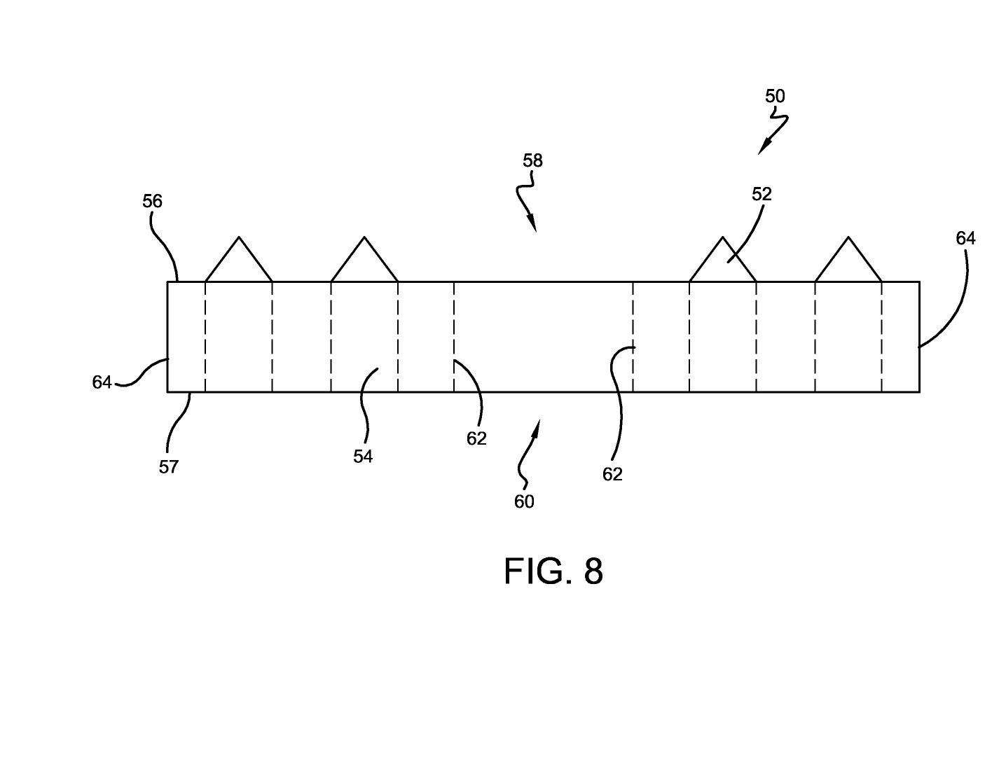

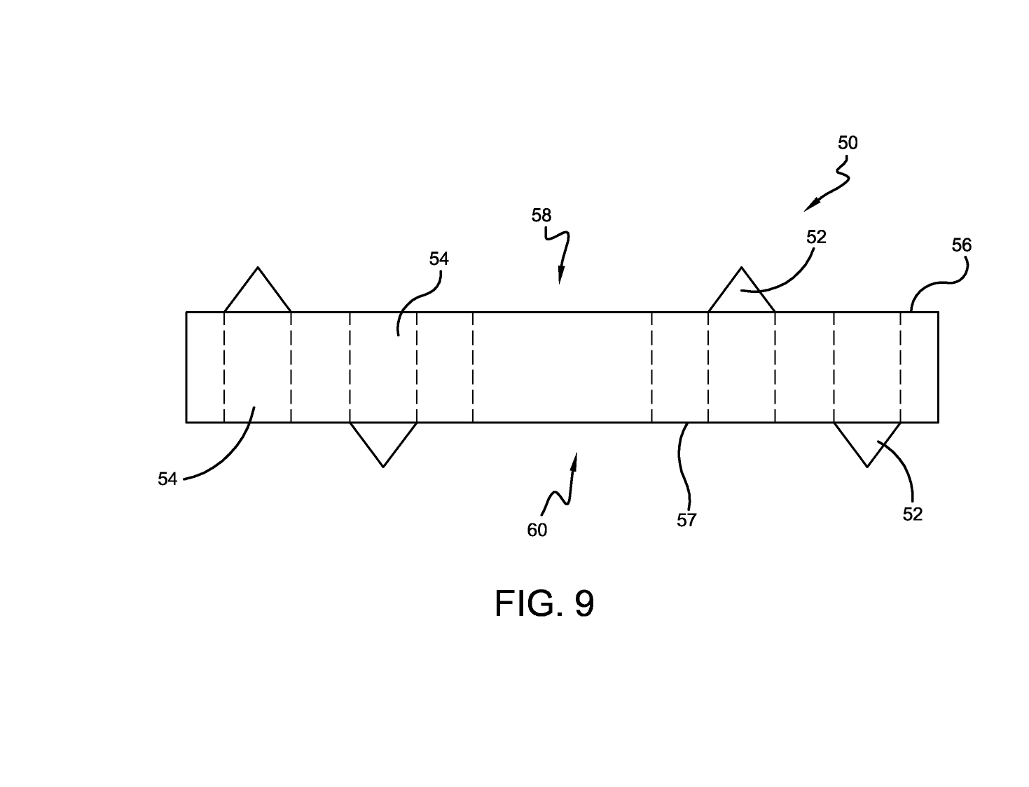

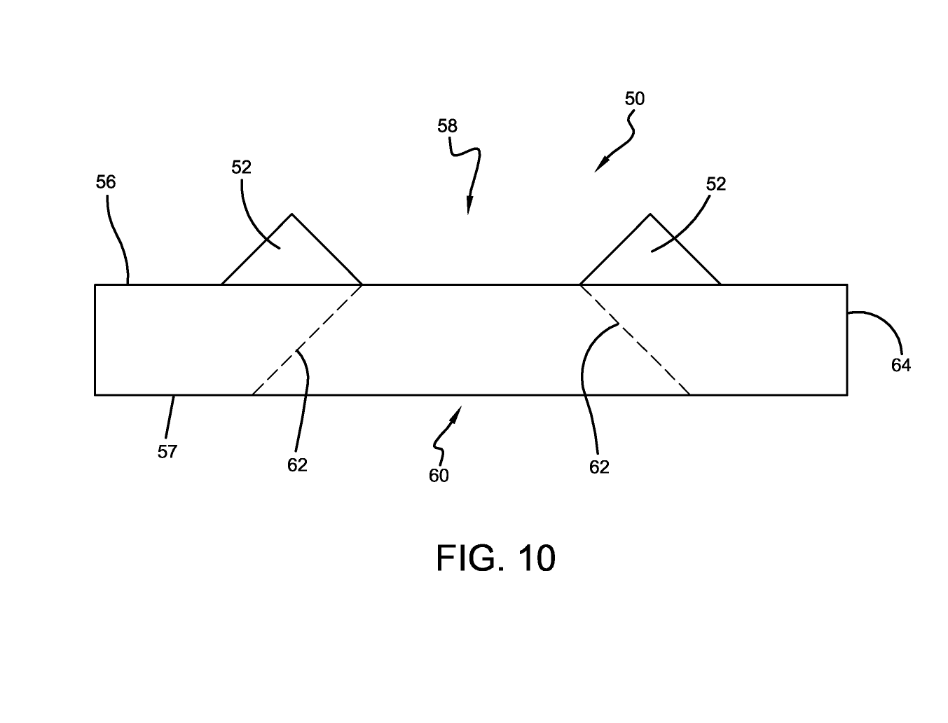

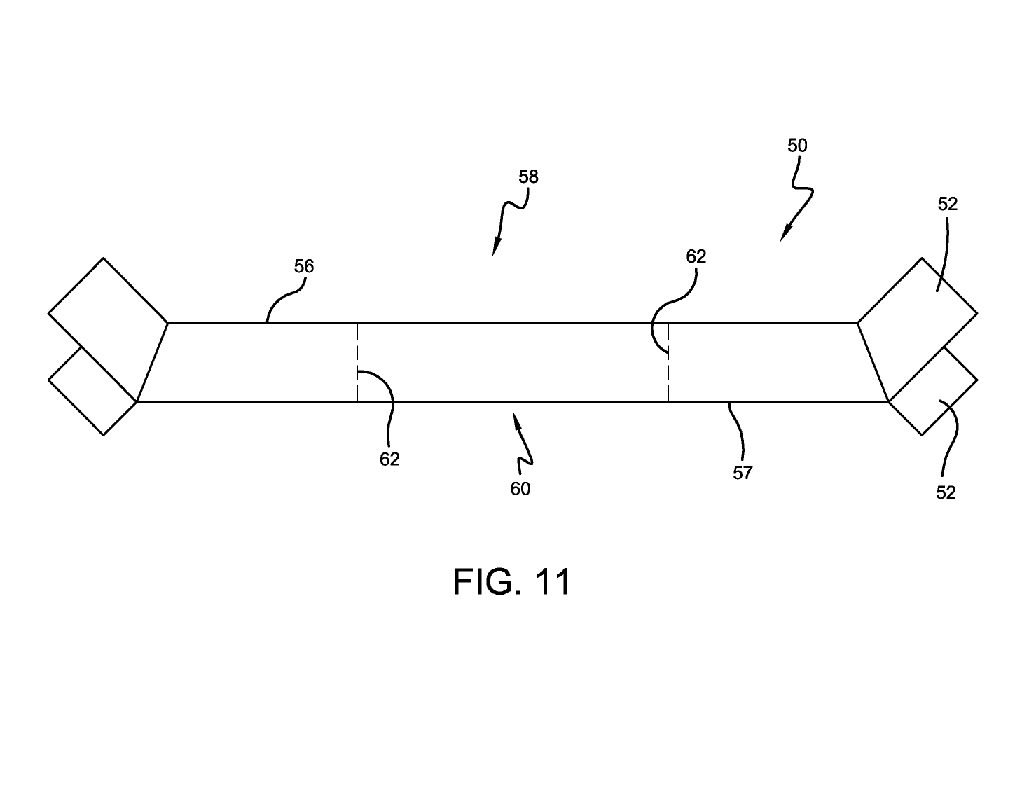

With reference now to FIGS. 5-9, the electrical grounding apparatus 50 is a washer with raised or elevated portions 52, according to some embodiments. The washer 50 can have various shapes including, but not limited to, substantially elliptical, substantially circular, substantially rectangular, or substantially square. The washer 50 can have an outer wall or periphery 64 and an inner wall or periphery 62 spaced apart from the outer wall 62. The inner wall 62 can define an aperture 65, which can receive a fastener, according to some embodiments. The elevated portions 52 can extend above the surface 56 of the washer 50. The elevated portions 52 can increase the surface area of the surface 56 for improved electrical connection. The elevated portions 52 can be stamped into the washer 50 creating apertures 54 in the washer 50. The apertures 54 can extend through the width of the washer 50, as shown in FIGS. 7-9. The washer 50 can include elevated portions or notches 50 on one side 58 of the washer 50, a shown in FIGS. 6-8 and 10, or on both sides 58, 60 of the washer 50, as shown in FIGS. 9 and 11. When the washer 50 includes elevated portions 52 on both sides 58, 60, then the elevated portions 52 can extend above the respective surfaces 56, 57 of the washer 50, as shown in FIGS. 9 and 11. The notches 50 can include various patterns from sparsely populated, as shown in FIG. 7, to more densely populated, as shown in FIG. 6. The notches 50 can also extend from the inside periphery 62, as shown in FIG. 10, or the outside periphery 64, as shown in FIG. 11, or both peripheries 62, 64.

Many different patterns and configurations of the elevated portions 52 have been contemplated and are within the scope of this invention. In addition, many different shapes of the elevated portions 52 have been contemplated and are within the scope of this invention.

Various combinations of the elevated portions 52 shown in FIGURES can be utilized and are within the scope of this invention. For one non-limiting example, the elevated portions 52 have different sizes and shapes on one side 58 or both sides 58, 60 of the electrical grounding apparatus 50. For another non-limiting example, the elevated portions 52 have different patterns or configurations within different regions on one side 58 or both sides 58, 60 of the electrical grounding apparatus 50.

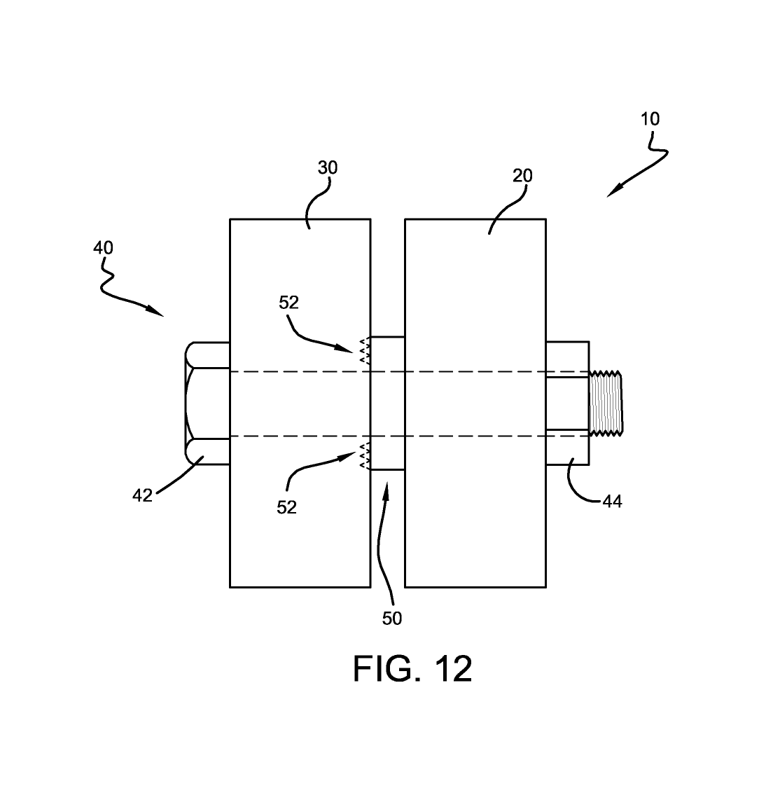

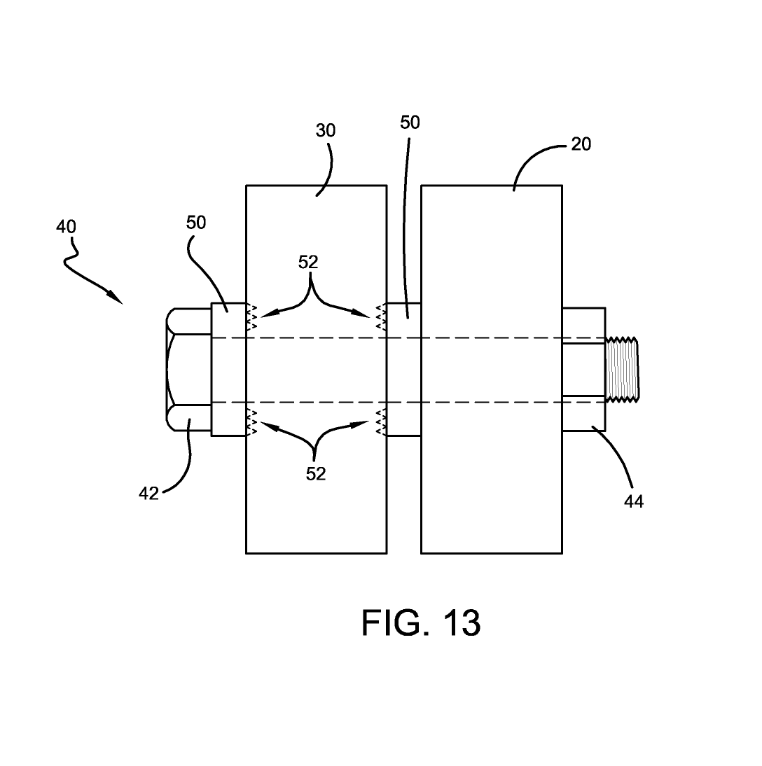

With reference now to FIGS. 12 and 13, the fastener 40 has secured the conductive plastic 30 to the component 20 of the automotive body-in-white 10. The electrical grounding apparatus 50 is secured between the conductive plastic 30 and the component 20. The elevated portions 52 at least partially extend into the conductive plastic 30. The embedded notches 52 on the washer 50 ensure the conductive plastic 30 is electrically connected to the metallic portion 20 of the body-in-white 10. In FIG. 13, a second electrical grounding apparatus 50 is secured between the conductive plastic 30 and the fastener 40. The elevated portions 52 on the second electrical grounding apparatus 50 at least partially extend into the conductive plastic 30. The embedded notches 52 on the second washer 50 ensure the conductive plastic 30 is electrically connected to the fastener 40, which is electrically connected to the metallic portion 20 of the body-in-white 10.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. An electrical grounding apparatus for a vehicle having a first component formed of an electrical conductive plastic and a second component formed of an electrical conducting material, the electrical grounding apparatus comprising:
an outer wall;
an inner wall spaced apart from the outer wall;
a first contacting surface comprising a plurality of elevated portions, wherein the first contacting surface makes electrical contact with the first vehicle component, and wherein the elevated portions extend at least partially into the first vehicle component; and
a second contacting surface, wherein the second contacting surface makes electrical contact with the second vehicle component;
wherein the electrical grounding apparatus is substantially formed of an electrically conductive material, which provides electrical contact between the first and second vehicle components.

2. The electrical grounding apparatus of claim 1, wherein the second contacting surface comprising a plurality of elevated portions, which extend at least partially into the first vehicle component.

3. The electrical grounding apparatus of claim 1, wherein both the outer wall and the inner wall are substantially circular.

4. The electrical grounding apparatus of claim 1, wherein the electrical grounding apparatus is formed of a substantially metallic material.

5. The electrical grounding apparatus of claim 1, wherein the electrical grounding apparatus is substantially formed of metal.

6. A vehicle painting apparatus comprising:
a first vehicle component formed of an electrical conductive plastic;
a second vehicle component formed of an electrically conductive material, wherein the second vehicle component is electrically grounded; an electrical grounding apparatus substantially formed of an electrically conductive material, the electrical grounding apparatus comprising:
an outer wall;
an inner wall spaced apart from the outer wall;
a first contacting surface comprising a plurality of elevated portions, wherein the first contacting surface makes electrical contact with the first vehicle component, and wherein the elevated portions extend at least partially into the first vehicle component; and
a second contacting surface, wherein the second contacting surface makes electrical contact with the second vehicle component; and
an electrostatic paint spraying system providing paint for the first and second vehicle components.

7. The vehicle painting apparatus of claim 6, wherein the second vehicle component is substantially formed of a metallic material.

8. The vehicle painting apparatus of claim 6, wherein the second vehicle component is substantially formed of a metal.

9. The vehicle painting apparatus of claim 6, wherein both the outer wall and the inner wall are substantially circular.

10. The vehicle painting apparatus of claim 6, wherein the electrical grounding apparatus is substantially metallic.

11. The vehicle painting apparatus of claim 6, wherein the electrical grounding apparatus is substantially metal.

12. The vehicle painting apparatus of claim 6 further comprising:
a fastener;
a second electrical grounding apparatus substantially formed of an electrically conductive material, the second electrical grounding apparatus comprising:
an outer wall;
an inner wall spaced apart from the outer wall;
a first contacting surface comprising a plurality of elevated portions, wherein the first contacting surface makes electrical contact with the first vehicle component, and wherein the elevated portions extend at least partially into the first vehicle component; and
a second contacting surface, wherein the second contacting surface makes electrical contact with the fastener;
wherein the fastener secures the first vehicle component to the second vehicle component, wherein the first electrical grounding apparatus is secured between the first and second vehicle components, and the second electrical grounding apparatus is secured between the fastener and the first vehicle component.

13. The vehicle painting apparatus of claim 12 wherein the second contacting surface of the second electrical grounding apparatus comprising a plurality of elevated portions, which extend at least partially into the fastener.

14. The vehicle painting apparatus of claim 6, wherein the electrostatic paint spraying system provides a positive charge to the first and second vehicle components and deposits negatively charged paint on the first and second vehicle components.

15. The method of grounding a vehicle component comprising:
providing a first vehicle component formed of an electrical conductive plastic;
providing a second vehicle component formed of an electrical conductive material, wherein the second vehicle component is electrically grounded;
providing an electrical grounding apparatus substantially formed of an electrically conductive material, the electrical grounding apparatus comprising:
an outer wall;
an inner wall spaced apart from the outer wall;
a first contacting surface comprising a plurality of elevated portions, wherein the first contacting surface makes electrical contact with the first vehicle component, and
wherein the elevated portions extend at least partially into the first vehicle component; and
a second contacting surface, wherein the second contacting surface makes electrical contact with the second vehicle component.
